(19) United States
(12) Patent Application Publication
(10) Pub. No.: US 2010/0274801 A1
(43) Pub. Date: Oct. 28, 2010

(54) ELECTRONIC APPARATUS

(75) Inventor: Ichiro Tomoda, Hamura-shi (JP)

Correspondence Address: PATTERSON & SHERIDAN, L.L.P., 3040 POST OAK BOULEVARD, SUITE 1500, HOUSTON, TX, 77056, US

(73) Assignee: Kabushiki Kaisha Toshiba, Tokyo (JP)

(21) Appl. No.: 12/751,428

(22) Filed: Mar. 31, 2010

(30) Foreign Application Priority Data
Apr. 22, 2009 (JP) 2009-104197

(51) Int. Cl. G06F 17/30

(52) U.S. Cl. 707/769; 707/E17.014

(57) ABSTRACT

According to one embodiment, an electronic apparatus includes a use history search process module configured to transmit a use history search message including model type information of a communication apparatus with which communication has been executed by a second communication process module in a communication method different from a communication method by a first communication process module, and the model type information of the electronic apparatus, to a server, a search result reception module configured to receive from the server a search result related to the use history search message, and an output module configured to output a message recommending communication with the communication apparatus by the first communication module, on the basis of the search result.

### CROSS-REFERENCE TO RELATED APPLICATIONS

This application is based upon and claims the benefit of priority from Japanese Patent Application No. 2009-104197, filed Apr. 22, 2009, the entire contents of which are incorporated herein by reference.

### BACKGROUND

1. Field

One embodiment of the invention relates to an electronic apparatus which executes communication with some other communication device.

2. Description of the Related Art

In general, in a case where a newly developed function is provided in an electronic apparatus such as a personal computer, it is possible that a user is unaware of such a new function. In particular, at the beginning of the prevalence of a new function, it is expected that many users are unaware of the presence of the new function. A user who does not know the presence of a new function cannot enjoy the convenience of using the new function, despite the user having the electronic apparatus with the new function.

For example, assume that both a personal computer and a digital camera, which have been newly purchased, are provided with new communication functions which can execute high-speed wireless data communication by simple operations. If the user is unaware of the provision of the new communication function, the user would use data communication by making use of an existing communication function, such as a USB (Universal Serial Bus). In the data communication using the USB, for example, the personal computer and the digital camera are connected by a cable, and photo data, which is recorded in the digital camera, is transmitted to the personal computer by data communication at a lower speed than the new communication function.

Jpn. Pat. Appln. KOKAI Publication No. 2003-52660 discloses a protocol/medical image registering system. In this system, complex photographing conditions (protocols), which need to be set at a time of scan in a high-level medical image diagnosis apparatus, are made available as common resources of many user terminals. In this system, in a case where new registration or update registration of a protocol or a medical image corresponding to this protocol has been instructed by an operator in a vender terminal, a new registration request or an update registration request is transmitted to a protocol management server. Upon receiving the registration request, the protocol management server newly registers or update-registers the protocol and medical image which are sent to a database from the vender terminal.

In the prior art, in the case where an electronic apparatus, such as a personal computer, is provided with a new communication function, the user needs to understand that the electronic apparatus is provided with the new communication function, for example, by reading the manual of the electronic apparatus. In addition, even if the user has the recognition that the electronic apparatus is provided with the new communication function, there are cases where the user is unable to understand in what situation the new communication function can be used. For example, even if the user recognizes that his/her own apparatus has a new communication function, it is difficult for the user to understand whether a communication-counterpart electronic apparatus has a similar new communication function, or what kind of process (application) can be executed by using the communication function between his/her own apparatus and the communication-counterpart electronic apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1A shows an example of the external appearance of a personal computer according to an embodiment;

FIG. 1B shows an example of the external appearance of a digital camera according to the embodiment;

FIG. 2 is an exemplary block diagram showing a main module configuration of the personal computer according to the embodiment;

FIG. 3 is an exemplary block diagram showing the module configuration of a recommendation system in a first embodiment;

FIG. 4 is an exemplary flow chart illustrating a use history collection process of a personal computer in the first embodiment;

FIG. 5 is an exemplary flow chart illustrating a use history registration process of a use history Web server in the first embodiment;

FIG. 6 shows an example of a use history registration message in the first embodiment;

FIG. 7 shows an example of a record which is recorded in a use history database in the first embodiment;

FIG. 8 is an exemplary flow chart illustrating a use history search process of the personal computer in the first embodiment;

FIG. 9 is an exemplary flow chart illustrating a use history search process of the use history Web server in the first embodiment;

FIG. 10 shows an example of a use history search message in the first embodiment;

FIG. 11 shows an example of a use history search result message in the first embodiment;

FIG. 12 shows a display example of a message recommending the use of close proximity wireless transfer in the first embodiment;

FIG. 13 is an exemplary block diagram showing the module configuration of a recommendation system in a second embodiment;

FIG. 14 is an exemplary flow chart illustrating a use history collection process of a personal computer in the second embodiment;

FIG. 15 is an exemplary flow chart illustrating a use history registration process of a use history Web server in the second embodiment;

FIG. 16 shows an example of a window for starting a program in the second embodiment;

FIG. 17 shows an example of a use history registration message in the second embodiment;

FIG. 18 shows an example of a record which is recorded in a use history database in the second embodiment;

FIG. 19 shows an example of a use history search message in the second embodiment;

FIG. 20 shows an example of a use history search result message in the second embodiment; and

FIG. 21 shows a display example of a message recommending the use of an application in the second embodiment.

### DETAILED DESCRIPTION

Various embodiments according to the invention will be described hereinafter with reference to the accompanying drawings. In general, according to one embodiment of the invention, there is provided an electronic apparatus comprising: a first communication module configured to execute communication with a first communication apparatus; a first model type information reception module configured to receive first model type information, which identifies the first communication apparatus which executes communication by the first communication module, from the first communication apparatus; a first transmission module configured to transmit a use history registration message including the first model type information and second model type information which identifies the own apparatus, to a server; a second communication module configured to execute communication with a second communication apparatus by a communication method different from a communication method by the first communication module; a second model type information reception module configured to receive, from the second communication apparatus, third model type information which identifies the second communication apparatus which executes communication by the second communication module; a second transmission module configured to transmit a use history search message including the third model type information and the second model type information, to the server, thereby to request a search for information corresponding to a combination of the third model type information and the second model type information; a search result reception module configured to receive from the server a search result in connection with the use history search message; and an output module configured to output a message recommending communication with the second communication apparatus by the first communication module, on the basis of the search result.

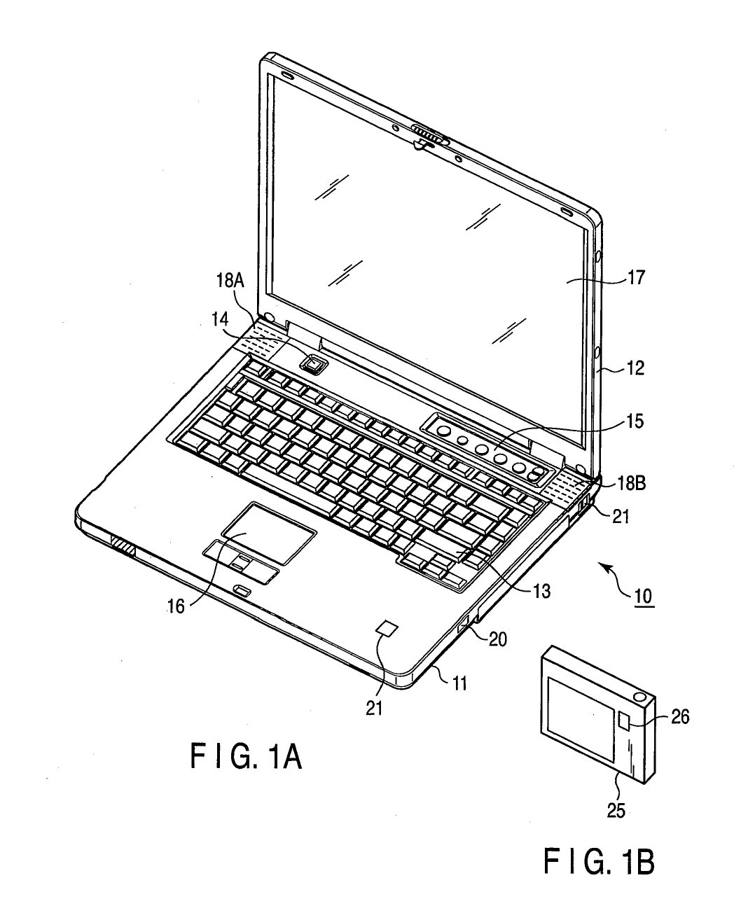

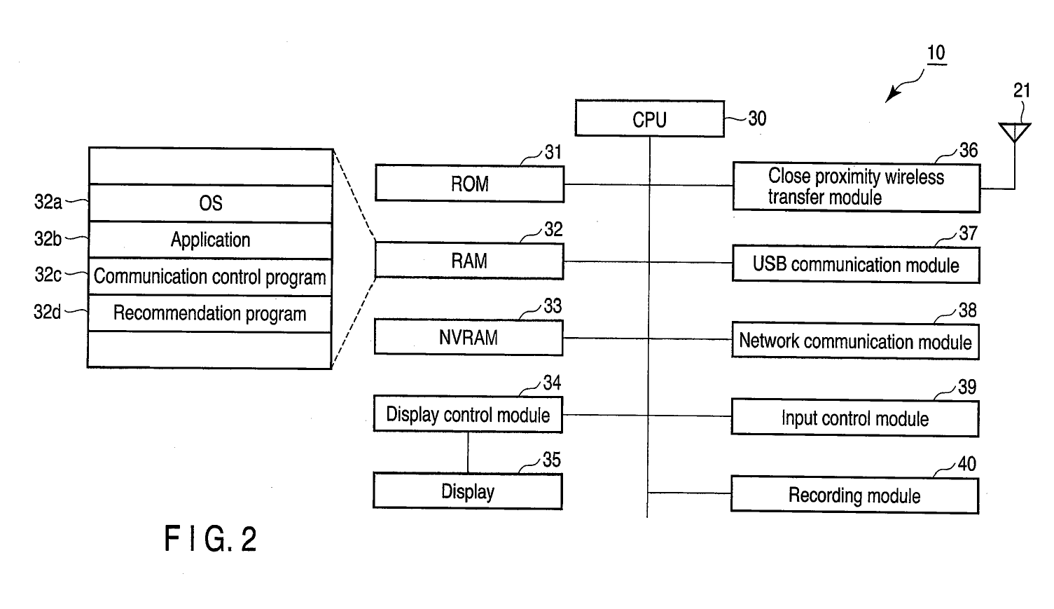

To begin with, with reference to FIG. 1A, FIG. 1B and FIG. 2, an electronic apparatus according to the embodiment of the invention is described. The electronic apparatus of this embodiment is realized, for example, as a notebook personal computer 10 shown in FIG. 1A.

The electronic apparatus of the present invention is not limited to the personal computer 10, and may be any apparatus in which a processor for executing programs is mounted and which is connectable to a network (Internet), such as a mobile phone, a PDA (personal digital assistant), a portable audio/video player, a digital video camera, and a portable car navigation apparatus.

FIG. 1A is a perspective view showing the personal computer 10 in the state in which a display unit thereof is opened. The personal computer 10 is composed of a computer main body 11 and a display unit 12. A display device, which is composed of an LCD (Liquid Crystal Display) 17, is built in the display unit 12.

The display unit 12 is attached to the computer main body 11 such that the display unit 12 is rotatable between an open position where the top surface of the computer main body 11 is exposed, and a closed position where the top surface of the computer main body 11 is covered. The computer main body 11 has a thin box-shaped housing. A keyboard 13, a power button 14 for power-on/power-off, an input operation panel 15, a touch pad 16, and speakers 18A and 18B are disposed on the top surface of the housing of the computer main body 11.

The input operation panel 15 is an input device for inputting an event corresponding to a pressed button. The input operation panel 15 includes a plurality of buttons for activating a plurality of functions.

A USB (Universal Serial Bus) connector 20 is provided on a side surface of the computer main body 11. By being connected to some other electronic apparatus via the USB connector 20, the personal computer 10 executes data communication according to the USB standard.

Further, an antenna 21 for close proximity wireless transfer is provided on an upper surface portion of the computer main body 11. The personal computer 10 is provided with a close proximity wireless transfer function for executing wireless communication with some other electric apparatus in the state in which the personal computer 10 is positioned close to the other electronic apparatus (e.g. within 3 cm). The personal computer 10 executes data communication with some other electronic apparatus, such as a digital camera 25 shown in FIG. 1B, via the antenna 21 for close proximity wireless transfer.

The digital camera 25 shown in FIG. 1 is provided with a close proximity wireless communication function for executing wireless communication with the personal computer 10 in the state in which the digital camera 25 is positioned close to the personal computer 10. The digital camera 25 is provided with an antenna 26 for close proximity wireless transfer, which is disposed, for example, on a back side of the housing thereof (usually, the side on which the display is provided). When the antenna 26 for close proximity wireless transfer is brought close to the antenna 21 for close proximity wireless transfer of the personal computer 10, the digital camera 25 executes close proximity wireless communication with the personal computer 10.

FIG. 2 is a block diagram showing a main module configuration of the personal computer 10 according to the embodiment.

As shown in FIG. 2, the personal computer 10 includes a CPU 30, a ROM 31, a RAM 32, an NVRAM (Non-volatile RAM) 33, a display control module 34, a display 35, a close proximity wireless transfer module 36 (close proximity wireless transfer antenna 21), a USB communication module 37, a network communication module 38, an input control module 39 and a recording module 40.

The CPU 30 executes overall control of the apparatus according to programs. The CPU 30 can execute a communication process of, for example, close proximity wireless transfer or USB communication, by executing a communication process program. In addition, the CPU 30 can recommend the use of close proximity wireless transfer by a kind of social filtering using a use history Web server 42 (to be described later), by executing a recommendation program.

The ROM 31 stores various programs and data.

The RAM 32 (main memory) temporarily stores various programs which are executed by the CPU 30, and data. The programs, which are stored in the RAM 32, include an operating system (OS) 32a, an application program 32b for executing various applications, a communication control program 32c for controlling various communications including close proximity wireless transfer and USB communication, and a recommendation program 32d for executing a recommendation process in the present embodiment. The recommendation process includes a use history collection process for causing the use history Web server 42 to collect an execution history of close proximity wireless transfer in a case where the close proximity wireless transfer is executed with some other electronic apparatus (digital camera 25), and also includes a use history search process for recommending the use of close proximity wireless transfer to the user by receiving the execution history of close proximity wireless transfer which has been executed by other users and registered in the use history Web server 42.

The NVRAM 33 stores various set data, and data which is processed by various programs.

The display control module 34 controls display on the display 35 under the control of the CPU 30.

The display 35 is composed of, for instance, an LCD (Liquid Crystal Display), and displays information relating to an ordinary process by the personal computer 10.

The close proximity wireless transfer module 36 executes close proximity wireless transfer with some other device under the control (close proximity wireless transfer control function) of the CPU 30. In the close proximity wireless transfer by the close proximity wireless transfer module 36, high-speed wireless communication which is purpose-specific for P2P (peer-to-peer) is executed. For instance, use may be made of a transfer method called “TransferJet”. The close proximity wireless transfer module 36 can execute wireless communication in the case where the communication distance between the close proximity wireless transfer antenna 21, which is provided on the housing, and an antenna, which is provided on the other device, is within 30 mm. The close proximity wireless transfer antenna 21 is a radio frequency antenna using an induction electric field. The radio frequency antenna using an induction electric field has such a feature that a high gain can be obtained in a short communication distance, and the gain sharply decreases with an increase in communication distance.

The USB communication module 37, under the control of the CPU 30, executes communication with some other device according to the USB (Universal Serial Bus) standard.

The network communication module 38, under the control of the CPU 30, executes communication with, e.g. the use history Web server 42, via a network 44 (Internet).

The input control module 39 controls inputs from the keyboard 13, touch pad 16 and various buttons.

The recording module 40 is composed of, for instance, a hard disk drive, and various programs and data are recorded in the recording module 40.

### First Embodiment

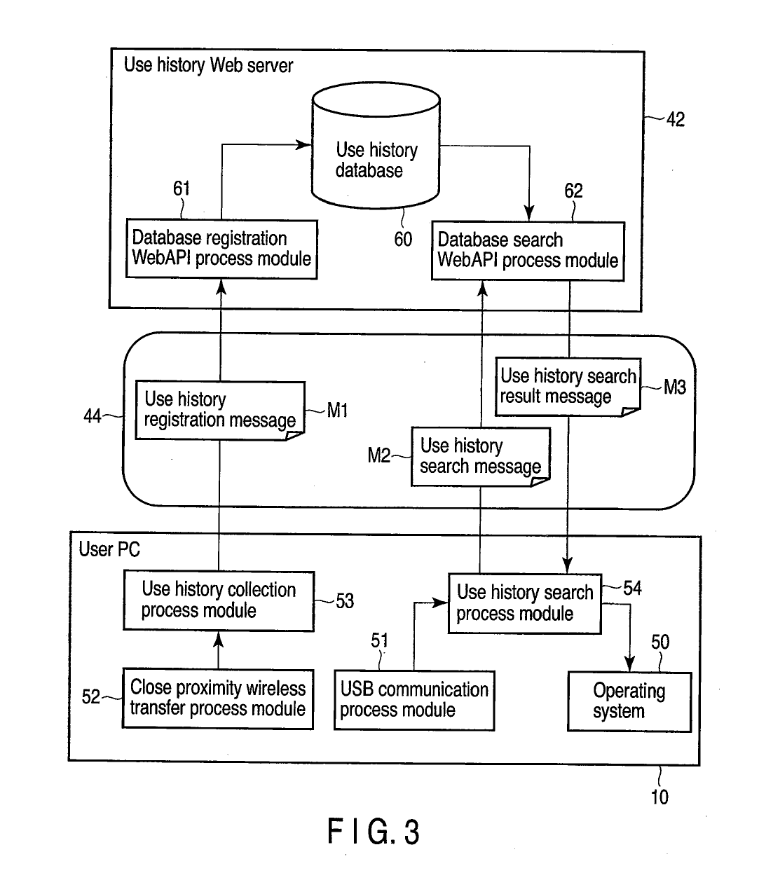

FIG. 3 is a block diagram showing the module configuration of a recommendation system in a first embodiment of the invention.

The recommendation system in the first embodiment is configured such that an electronic apparatus, such as a personal computer, and the use history Web server 42 are connected via the network 44 including the Internet.

The personal computer 10, as shown in FIG. 3, includes an operating system 50, a USB communication process module 51, a close proximity wireless transfer process module 52, a use history collection process module 53, and a use history search process module 54.

The operating system 50 (32a) executes overall control of the personal computer 10. The operating system 50 causes the display 35 to display, for example, a message for recommending the use of close proximity wireless transfer to the user, in accordance with a processing result by the use history search process module 54.

The USB communication process module 51 (second communication module) executes data communication according to the USB standard with some other electronic apparatus (communication apparatus) which has a communication function and is connected via the USB connector 20.

The close proximity wireless transfer process module 52 (first communication module) executes close proximity wireless transfer with some other electronic apparatus via the close proximity wireless transfer module 36.

The use history collection process module 53 and use history search process module 54 are realized by the execution of the recommendation program 32d by the CPU 30. In the case where close proximity wireless transfer with some other communication apparatus (e.g. digital camera 25) has been executed by the close proximity wireless transfer process module 52, the use history collection process module 53 receives model information (e.g. model name), which identifies the communication apparatus, from the communication apparatus via the close proximity wireless transfer process module 52. The use history collection process module 53 creates a use history registration message M1 including the received model information and model information which identifies the own apparatus (user PC 10), and transmits the use history registration message M1 so that the use history registration message M1 is registered in the use history Web server 52 which is connected via the network 44. In addition, the use history collection process module 53 can record the use history of other communication such as USB communication by the USB communication process module 51, as well as the use history of close proximity wireless transfer, in the use history web server 42 by the use history registration message M1.

When communication with a communication apparatus has been executed by the USB communication process module 51, the use history search process module 54 receives third model information, which identifies the communication apparatus, from the communication apparatus via the USB communication process module 51. The use history search process module 54 creates a use history search message M2 including the received model information and the model information identifying the own apparatus, and transmits the use history search message M2 to the use history Web server 42, thereby requesting a search for information corresponding to the combination between the model information of the communication apparatus and the model information of the own apparatus. The use history search process module 54 receives a use history search result message M3 indicating a search result from the use history Web server 42 in connection with the use history search message M2. On the basis of the received search result, the use history search process module 54 issues, through the operating system 50, an output for recommending to the user the communication with the communication apparatus by the close proximity wireless transfer process module 52.

On the other hand, the use history Web server 42 includes a use history database 60, a database registration WebAPI process module 61 and a database search WebAPI process module 62. The use history Web server 42 realizes the respective modules by the execution of the recommendation program by the processor.

The use history Web server 42 has a recommendation function, for example, as a Web service. In the recommendation function, the use history Web server 42 totalizes the use history of close proximity wireless transfer in various electronic apparatuses, which can execute close proximity wireless communication, in the use history database 60 in a centralized manner, and recommends the use of close proximity wireless transfer to the user, who uses the electronic apparatus which can execute close proximity wireless transfer, on the basis of the use history which is totalized by the use history database 60.

The database registration WebAPI process module 61 receives the use history registration message M1 from the personal computer 10, and records in the use history database 60 the model information of the personal computer 10 and the model information of the communication apparatus which executes close proximity wireless transfer with the personal computer 10, the model information being included in the use history registration message M1.

The database search WebAPI process module 62 receives the use history search message M2 from the personal computer 10, and searches for the information in the use history database 60, which corresponds to the combination between the model information of the personal computer 10 and the model information of the communication apparatus, the model information being included in the use history registration message M1. In addition, the database search WebAPI process module 62 creates the use history search result message M3 indicating a result of the search through the use history database 60, and transmits the use history search result message M3 to the personal computer 10.

Next, a description is given of the operation of the recommendation system in the first embodiment.

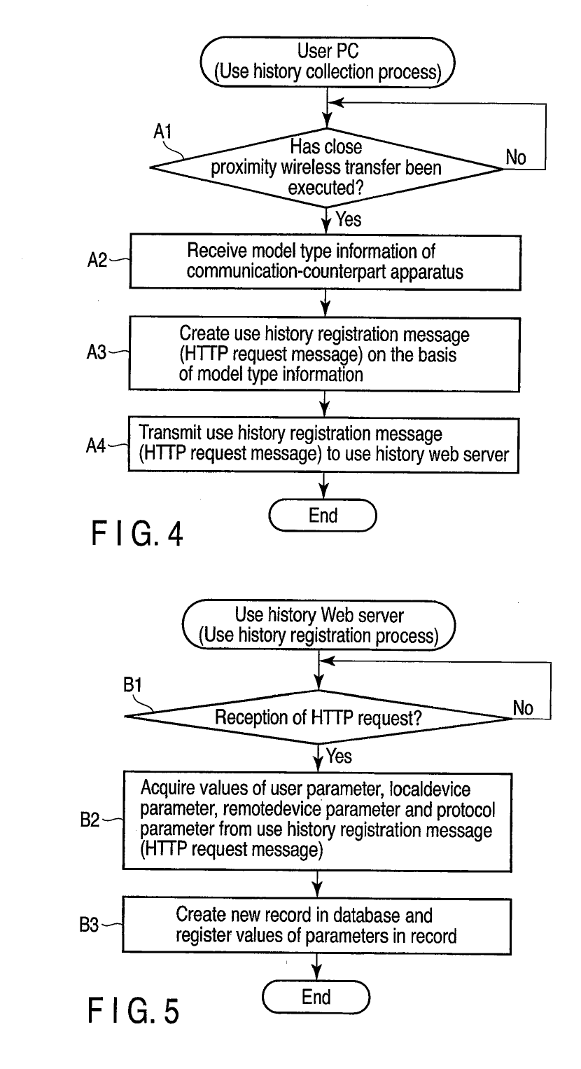

FIG. 4 is a flow chart illustrating a use history collection process in the personal computer 10 (user PC), and FIG. 5 is a flow chart illustrating a use history registration process in the use history Web server 42.

It is assumed that a user A has executed data communication by close proximity wireless transfer with the digital camera 25 with the model name “DSCX” (hereinafter referred to as “digital camera DSCX”) while the user A is using the personal computer 10 with the model name “PC1” (hereinafter “personal computer PC1”) (Yes in block A1).

The close proximity wireless transfer process module 52 of the personal computer PC1 acquires the “model name DSCX” of the digital camera DSCX, which is the communication counterpart, by the close proximity wireless protocol, and outputs the “model name DSCX” to the use history collection process module 53.

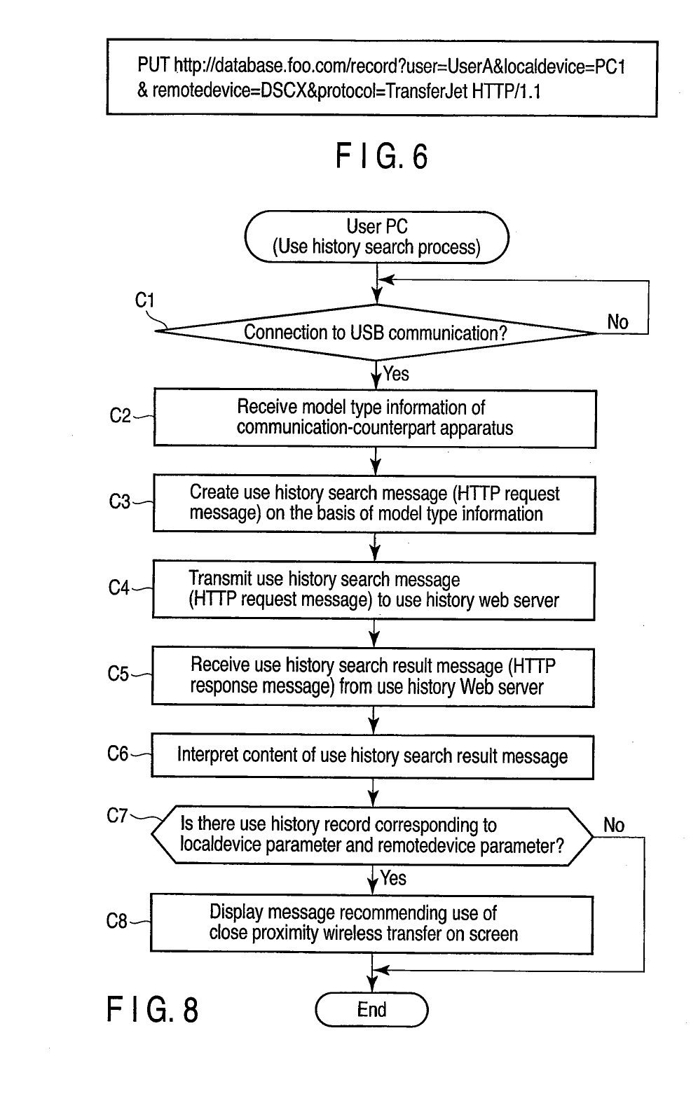

Upon receiving the “model name DSCX” of the communication-counterpart communication apparatus from the close proximity wireless transfer process module 52 (block A2), the use history collection process module 53 creates an HTTP request message (use history registration message M1), as shown in FIG. 6, on the basis of the “model name DSCX” and the model name “PC1” of the own apparatus (block A3), and transmits the HTTP request message to the use history Web server 42 through the Internet protocol (block A4). In this case, it is assumed that the domain name of the use history Web server 42 is “database.foo.com”. As shown in FIG. 6, the use history registration message M1 includes a user parameter “User”, a localdevice parameter “PC1”, a remotedevice parameter “DSCX”, and a protocol parameter “TransferJet”.

Upon receiving the use history registration message M1 (Yes in block B1), the database registration WebAPI process module 61 of the use history Web server 42 acquires the values of the user parameter, localdevice parameter, remotedevice parameter and protocol parameter (block B2), and creates a new record in the use history database 60, thereby registering these parameters in this record (block B3).

The use history database 60 of the use history Web server 42 stores the use history data from various users (the data acquired from the use history registration message M1) in a database format in a centralized manner.

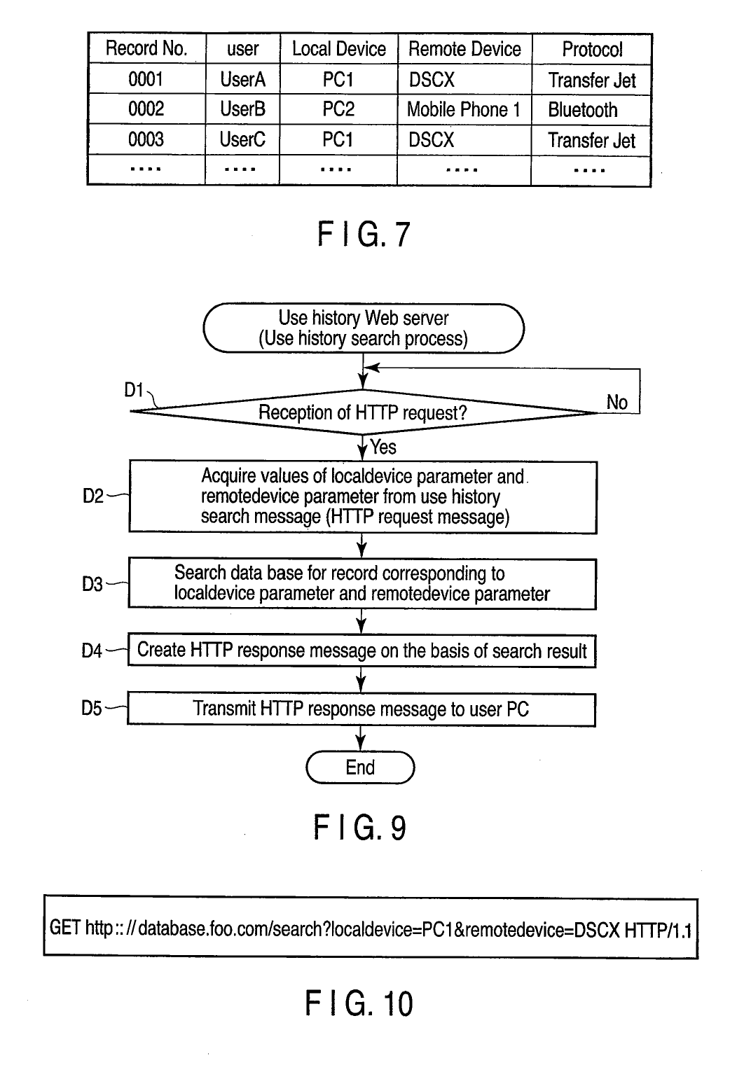

FIG. 7 shows an example of the record which is stored in the use history database 60. In the example of FIG. 7, the use history database 60 stores, in addition to the record (record No. 0001) which is registered by the use history registration message M1 shown in FIG. 6, a record indicating that a user B has executed communication by Bluetooth® between a personal computer “model name PC2” and a mobile phone “model name MobilePhone1”, and a record indicating that a user C has executed communication by close proximity wireless transfer between the personal computer “model name PC1” and the digital camera “model name DSCX”.

FIG. 8 is a flow chart illustrating a use history search process in the personal computer 10 (user PC), and FIG. 9 is a flow chart illustrating a use history search process in the use history Web server 42.

It is assumed that another user X has connected the digital camera DSCX to the USB connector 20 while the personal computer PC1 is being used (Yes in block C1).

The USB communication process module 51 of the personal computer PC1 acquires a value of the product name field in a USB device descriptor which is received from the digital camera DSCX, and outputs this value to the use history search process module 54. In this case, the value of the product name field is “model name DSCX”. The digital camera DSCX is a communication apparatus which can execute close proximity wireless transfer.

Upon receiving the “model name DSCX” of the communication-counterpart from the USB communication process module 51 (block C2), the use history search process module 54 creates an HTTP request message (use history search message M2), as shown in FIG. 10, on the basis of the “model name DSCX” and the model name “PC1” of the own apparatus (block C3), and transmits the HTTP request message to the use history Web server 42 through the Internet protocol (block C4). As shown in FIG. 10, the use history search message M2 includes a localdevice parameter “PC1”, and a remotedevice parameter “DSCX”.

Upon receiving the use history search message M2 (Yes in block D1), the database search WebAPI process module 62 of the use history Web server 42 acquires the values of the localdevice parameter and remotedevice parameter from the use history search message M2 (block D2), and searches the use history database 60 for a record corresponding to the combination between the localdevice parameter and remotedevice parameter (block D3). As a result of the search through the use history database 60, the database search WebAPI process module 62 obtains two records, Record No. 0001 and Record No. 0003.

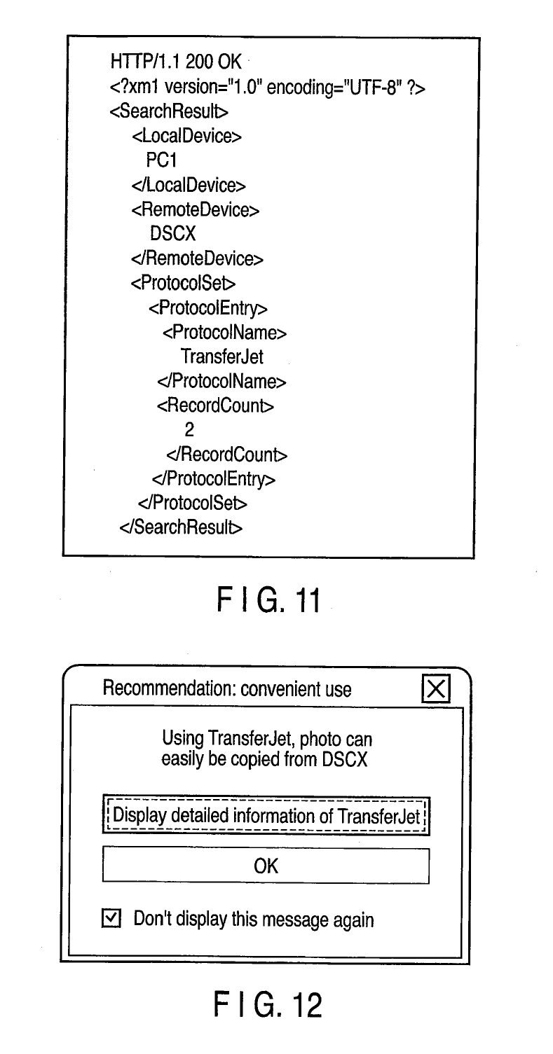

Using the search result of the use history database 60, the database search WebAPI process module 62 creates an HTTP response message (use history search result message M3) (block D4), as shown in FIG. 11, and transmits the HTTP response message to the personal computer PC1 (block D5).

If the use history search process module 54 of the user PC receives the use history search result message M3 (block C5), the use history search process module 54 interprets the content of the use history search result message M3 (block C6). As a result of the interpretation, the use history search process module 54 determines that there are two records as the records corresponding to the combination between the localdevice parameter and remotedevice parameter (RecordCount=2). As a result, the use history search process module 54 determines that the use of close proximity wireless transfer should be recommended to the user for the communication with the digital camera DSCX (Yes in block C7). In this case, through the operating system 50, the use history search process module 54 causes the display 35 to display a screen for recommending the use of close proximity wireless transfer to the user (block C8).

FIG. 12 shows a display example of the message recommending the use of close proximity wireless transfer. The message may be output to the user, not only by a screen display mode, as shown in FIG. 12, but also by other modes, such as a voice message mode.

On the other hand, in the case where the result of interpretation of the content of the use history search result message M3 shows that there is no use history record of close proximity wireless transfer, which corresponds to the combination between the localdevice parameter and remotedevice parameter (RecordCount=0), the use history search process module 54 determines that the use of close proximity wireless transfer is not recommended to the user for the communication with the digital camera DSCX. In this case, the use history search process module 54 does not request the operating system 50 to output the message.

As has been described above, in the first embodiment, in the use history database 60 of the use history Web server 42, the history of use by many users of the electronic apparatuses having the close proximity wireless transfer functions (the combinations of model names) is totalized in a centralized manner. Thus, with the use of the use history database 60, the use of close proximity wireless transfer can be recommended to the user. Specifically, since the entries indicating the combinations of electronic apparatuses by which many uses have actually executed close proximity wireless transfer are accumulated in the use history database 60, there is no need to independently accumulate in the server the information relating to the electronic apparatuses having the close proximity wireless transfer functions.

In the recommendation system in the present embodiment, when the user tries to execute communication by USB with use of an electronic apparatus which can execute close proximity wireless transfer, the user is recommended to use the close proximity wireless transfer which can execute data communication at higher speed by a simpler operation than the USB. Therefore, the convenience for the user can be improved.

In the above description, it is determined that the use of close proximity wireless transfer should be recommended, in the case where there are two entries corresponding to the combination of the localdevice parameter and the remotedevice parameter, which are indicated to the use history Web server 42 by the use history search message M2. However, the number of entries, which correspond to the combination of the localdevice parameter and the remotedevice parameter, may be at least one.

Alternatively, it may be determined that the use of close proximity wireless transfer should be recommended, in the case where the number of entries corresponding to the combination of the localdevice parameter and the remotedevice parameter, which are recorded in the use history database 60, is greater than a preset number. Specifically, in the case where the number of entries is greater than the preset number, the data communication mode, which is used by many users, is indicated, and the use of the close proximity wireless transfer can be recommended as being reliable.

### Second Embodiment

Next, a second embodiment of the invention is described.

In the first embodiment, the apparatus information of the apparatus, which executes close proximity wireless transfer, is registered as a use history in the use history Web server 42. In the second embodiment, in addition to the first embodiment, the use of an application, which is executed in data communication with the other communication apparatus in the close proximity wireless transfer, is recorded as a use history in the use history database 60. Thereby, when data communication by close proximity wireless communication is executed between electronic apparatuses of the same combination, a usable application can be recommended.

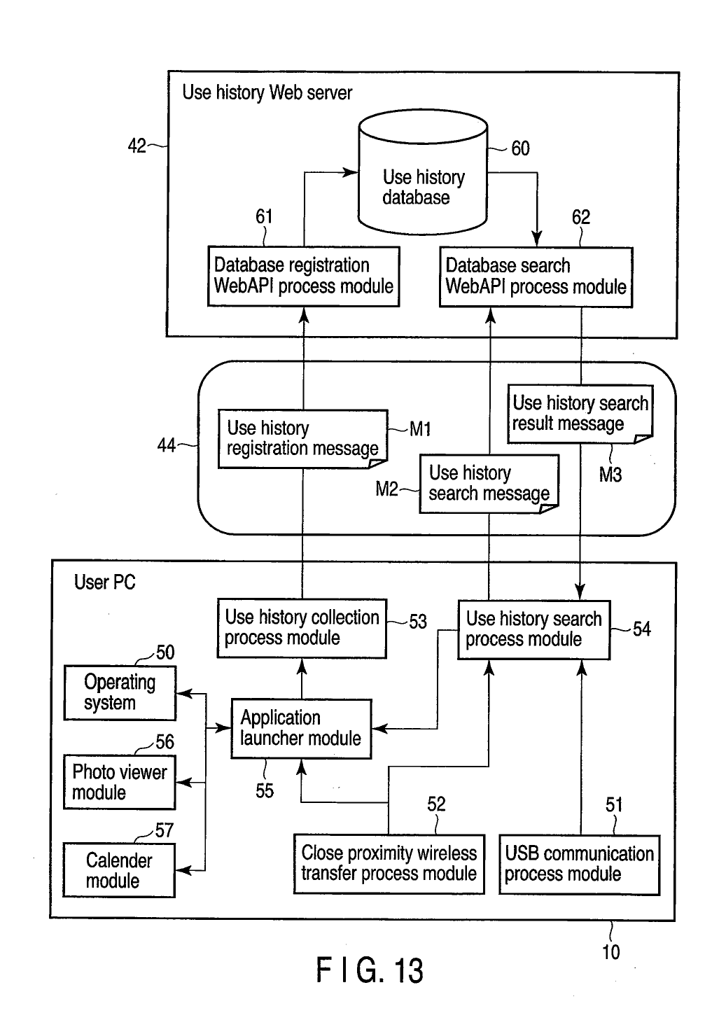

FIG. 13 is a block diagram showing the module configuration of a recommendation system in the second embodiment.

As shown in FIG. 13, the personal computer 10 includes an operating system 50, a USB communication process module 51, a close proximity wireless transfer process module 52, a use history collection process module 53, a use history search process module 54, an application launcher module 55, a photo viewer module 56, and a calendar module 57. Those modules, which execute substantially the same operations as in the first embodiment, are denoted by like reference numerals, and a detailed description thereof is omitted here.

The application launcher module 55 has a function of starting an application which is installed in the personal computer 10, under the control of the operating system 50.

The photo viewer module 56 and calendar module 57 are application modules which are realized by the execution of the application program 32b by the CPU 30. The photo viewer module 56 reproduces and displays photo data which is received from, for instance, a communication-counterpart mobile phone or digital camera 25. The calendar module 57 executes a process for achieving matching with data which is recorded in a schedule function which is provided in, for instance, a communication-counterpart mobile phone.

Next, the operation of the recommendation system in the second embodiment is described.

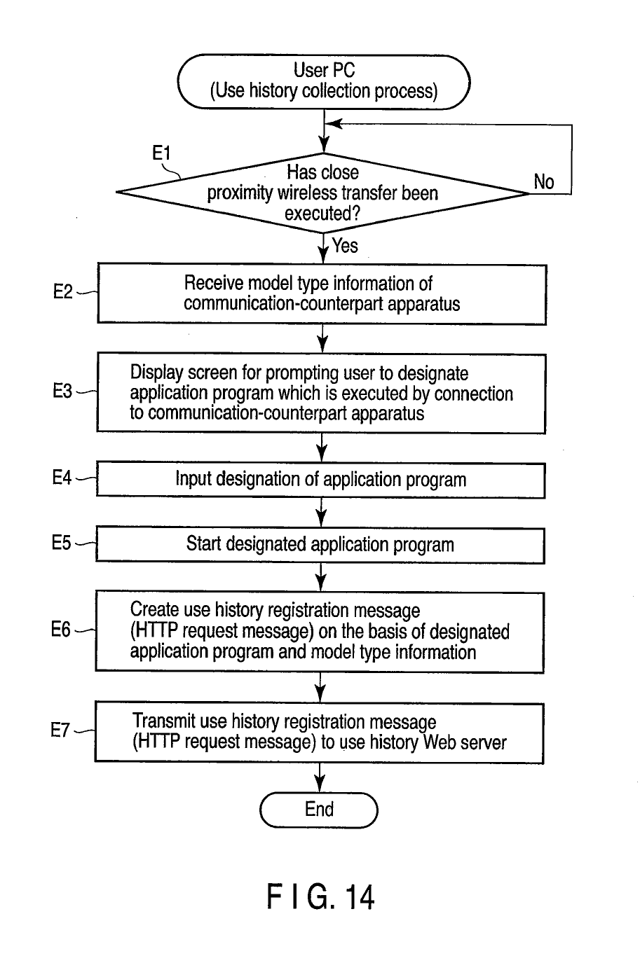

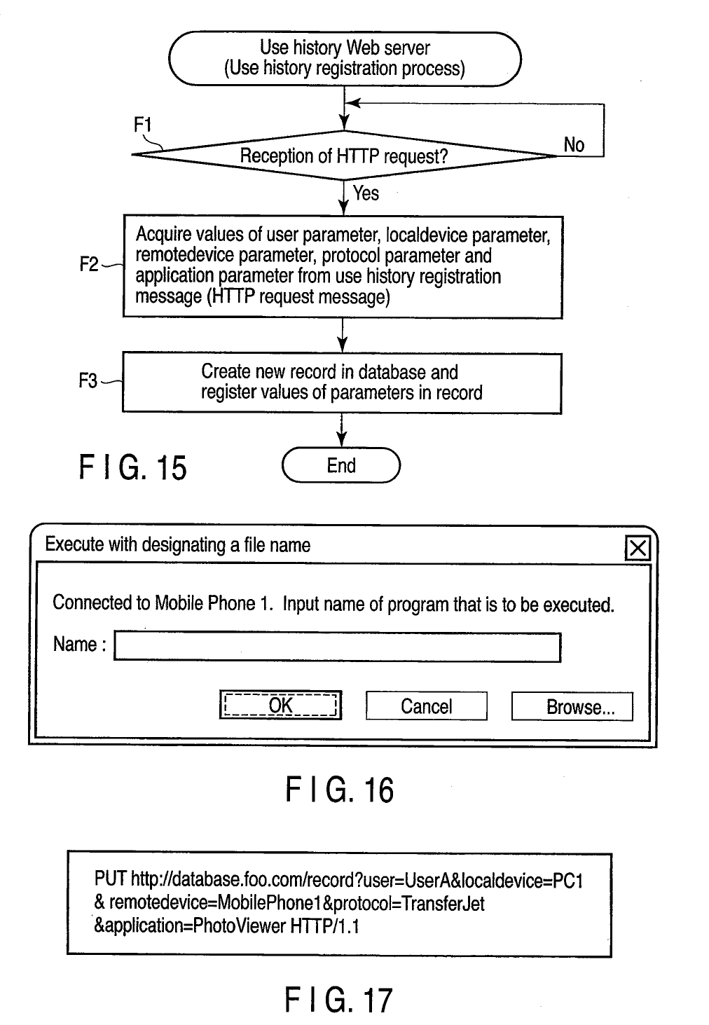

FIG. 14 is a flow chart illustrating a use history collection process in the personal computer 10 (user PC), and FIG. 15 is a flow chart illustrating a use history registration process in the use history Web server 42.

It is assumed that a user A has executed connection by close proximity wireless transfer with a mobile phone with the model name “MobilePhone1” (hereinafter referred to as “mobile phone MobilePhone1) while the user A is using the personal computer with the model name “PC1” (Yes in block E1).

The close proximity wireless transfer process module 52 of the personal computer PC1 acquires the “model name MobilePhone1”, which is the communication counterpart, by the close proximity wireless protocol, and informs the application launcher module 55 of the connection to the MobilePhone1.

Upon receiving the “model name MobilePhone1” from the close proximity wireless transfer process module 52 (block E2), the application launcher module 55 effects display of a window, as shown in FIG. 16, for starting a program through the operating system 50 (block E3). In this window, the user inputs the program name of a program to be executed, thereby starting the associated application. Assume now that the user has input “PhotoViewer” in order to start the photo viewer module 56 (block E4).

Then, the application launcher module 55 determines the application to be executed, and starts the photo viewer module 56 that is the application (block E5) and outputs to the use history collection process module 53 the information that the photo viewer module 56 (PhotoViewer application) has been selected in the connection to the mobile phone MobilePhone1.

The use history collection process module 53 creates an HTTP request message (use history registration message M1), as shown in FIG. 17, on the basis of the input from the application launcher module 55 (block E6), and transmits the HTTP request message to the use history Web server 42 through the Internet protocol (block E7). In this case, it is assumed that the domain name of the use history Web server 42 is “database.foo.com”. As shown in FIG. 17, the use history registration message M1 includes a user parameter “User”, a localdevice parameter “PC1”, a remotedevice parameter “DSCX”, a protocol parameter “TransferJet”, and an application parameter “PhotoViewer”.

Upon receiving the use history registration message M1 shown in FIG. 17 (Yes in block F1), the database registration WebAPI process module 61 of the use history Web server 42 acquires the values of the user parameter, localdevice parameter, remotedevice parameter, protocol parameter and application parameter, creates a new record in the database, thereby registering these parameters in this record (block F2).

The database of the use history Web server 42 stores the use history data from various users (the data acquired from the use history registration message M1) in a database format in a centralized manner.

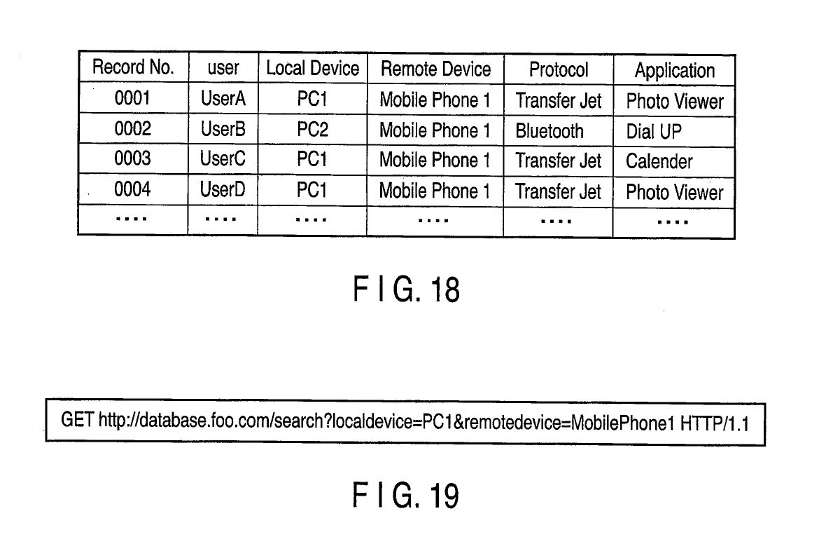

FIG. 18 shows an example of the record which is stored in the use history database 60 in the second embodiment. In the example of FIG. 18, the use history database 60 stores, in addition to the record (record No. 0001) which is registered by the use history registration message M1 shown in FIG. 17, a record No. 0002 indicating that a user B has executed connection by Bluetooth® between a personal computer “model name PC2” and the mobile phone “model name MobilePhone1” and also indicating that a DialUp application program has been used, a record No. 0003 indicating that a user C has executed connection by close proximity wireless transfer between the personal computer “model name PC1” and the mobile phone “model name MobilePhone1” and also indicating that the calendar application has been used, and a record No. 0004 indicating that a user D has executed connection by close proximity wireless transfer between the personal computer PC1 and the mobile phone “model name MobilePhone1” and also indicating that the PhotoViewer application has been used.

Next, the use history search process in the second embodiment is described. Flow charts are not shown with respect to the use history search process which is executed by the personal computer PC1, and the use history search process which is executed by the use history Web server 42, since these processes are assumed to be executed in the same manner as in the flow charts of FIG. 8 and FIG. 9.

It is assumed that another user X has executed connection to the mobile phone MobilePhone1 while the personal computer PC1 is being used (it is determined in block C1 that connection by close proximity wireless transfer has been executed).

The close proximity wireless transfer process module 52 of the personal computer PC1 acquires “model name MobilePhone1” of the communication-counterpart mobile phone MobilePhone1 by the close proximity wireless protocol, and outputs the “model name MobilePhone1” to the use history search process module 54.

Upon receiving the “model name MobilePhone1” from the close proximity wireless transfer process module 52, the use history search process module 54 creates an HTTP request message (use history search message M2), as shown in FIG. 19, and transmits the HTTP request message to the use history Web server 42 through the Internet protocol.

Upon receiving the use history search message M2, the database search WebAPI process module 62 of the use history Web server 42 searches the use history database 60 for a record corresponding to the combination between the localdevice parameter and remotedevice parameter. As a result of the search through the use history database 60, the database search WebAPI process module 62 obtains three records, Record No. 0001, Record No. 0003 and Record No. 0004.

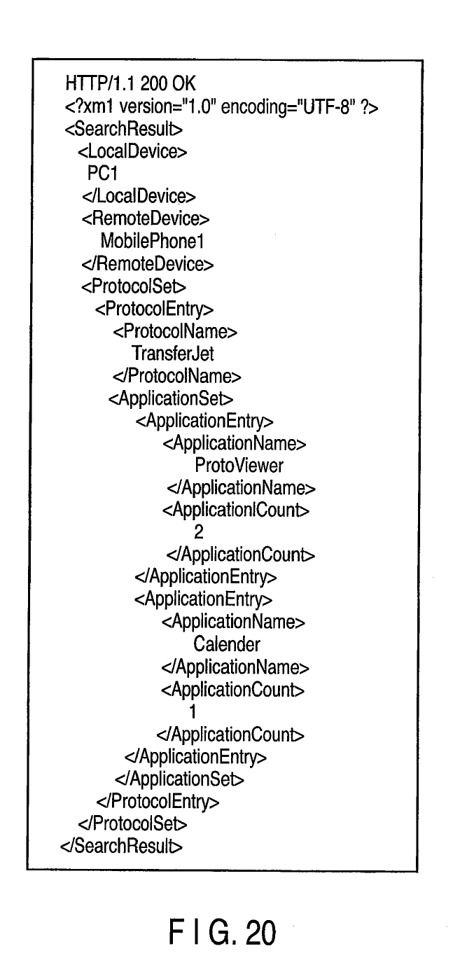

Using the search result of the use history database 60, the database search WebAPI process module 62 creates an HTTP response message (use history search result message M3), as shown in FIG. 20, and transmits the HTTP response message to the personal computer PC1.

If the use history search process module 54 of the user PC receives the use history search result message shown in FIG. 20, the use history search process module 54 interprets the content of the use history search result message M3. As a result of the interpretation, the use history search process module 54 determines that as the records corresponding to the combination between the localdevice parameter and remotedevice parameter, there are two records indicating that the PhotoViewer application has been used, and there is one record indicating that the calendar application has been used. As a result, the use history search process module 54 determines that the use of the PhotoViewer application and the calendar application by the data communication with the mobile phone MobilePhone1 should be recommended. In addition, on the basis of the order of the number of records, the use history search process module 54 determines that the PhotoViewer application should first be recommend, and the calendar application should secondly be recommended. In this case, through the operating system 50, the use history search process module 54 causes the display 35 to display a screen for recommending the application which is to be executed by using close proximity wireless transfer.

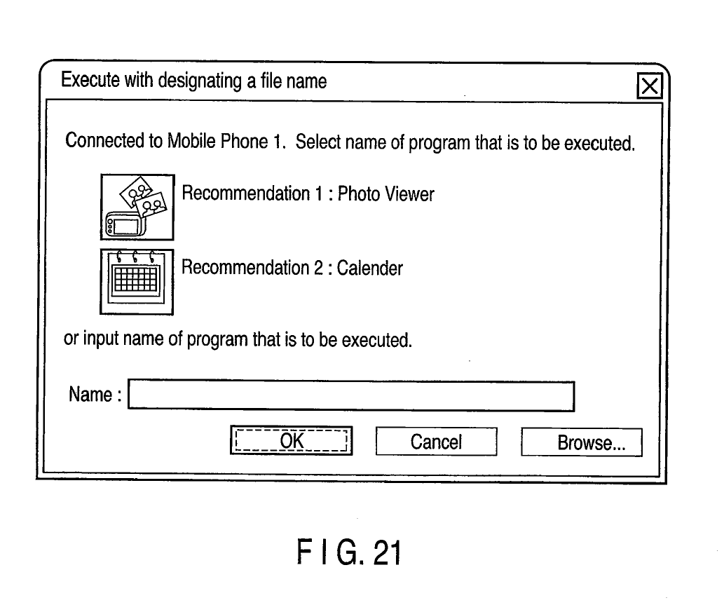

FIG. 21 shows a display example of the message recommending the use of the application. The message may be output to the user, not only by a screen display mode, as shown in FIG. 21, but also by other modes, such as a voice message mode.

On the display screen shown in FIG. 21, the user can arbitrarily designate the application to be started. If the application name is designated, the application launcher module 55 starts the corresponding application program, namely the photo viewer module 56 or calendar module 57. Thereby, a process by the started application can be executed for the data that is transmitted/received by the close proximity wireless transfer which is executed by the close proximity wireless transfer process module 52.

As has been described above, in the second embodiment, in addition to the first embodiment, the execution of an application by many users, which makes use of close proximity wireless transfer, is totalized as a use history in a centralized manner in the use history database 60 of the use history Web server 42. Thus, the application, which is used in the case of using the close proximity wireless transfer, can be recommended to the user by using the use history database 60. Therefore, when the user executes communication with some other device by using close proximity wireless transfer, the user can easily select a proper application and execute the selected application even if the user does not know available applications. The convenience for the user can be improved.

In the above-description, the personal computer 10 receives from the use history Web server 42 the search result in connection with the records registered in the use history database 60, and determines, on the basis of the received search result, whether or not to display the screen for recommending the use of close proximity wireless communication. Alternatively, the use history Web server 42 may determine whether or not to recommend the use of close proximity wireless transfer, on the basis of the search result in connection with the records registered in the use history database 60. The personal computer 10 receives the message indicating the determination result in the use history Web server 42, and displays the screen for recommending the user of close proximity wireless transfer in the case where it is determined that the use of close proximity wireless transfer is recommended.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first communication module configured to communicate with a first communication apparatus by a first communication method;
a first reception module configured to receive first model type information, which identifies the first communication apparatus, from the first communication apparatus;
a first transmission module configured to transmit a use history registration message including the first model type information received by the first reception module and second model type information which identifies the electronic apparatus, to a server connected via a network;
a second communication module configured to communicate with a second communication apparatus by a second communication method;
a second reception module configured to receive, from the second communication apparatus, third model type information which identifies the second communication apparatus;
a second transmission module configured to transmit a use history search message including the third model type information received by the second reception module and the second model type information, to the server in order to request a search for information corresponding to a combination of the third model type information and the second model type information;
a search result reception module configured to receive from the server a search result related to the use history search message; and
an output module configured to output a message recommending communication with the second communication apparatus by the first communication module based on the search result.

2. The electronic apparatus of claim 1, wherein the first communication method comprises a close proximity wireless transfer method.

3. The electronic apparatus of claim 1, further comprising a determination module configured to determine an application which is executed in association with the first communication apparatus,
wherein the first transmission module is configured to transmit the use history registration message including information indicative of the application which is determined by the determination module, to the server, and
the output module is configured to output a message recommending use of the application, on the basis of information indicative of the application, which is included in the search result.

4. The electronic apparatus of claim 1, wherein the search result comprises a number of information items corresponding to a combination of the third model type information and the second model type information, which are included in the use history search message, and
the output module is configured to output a message recommending communication with the second communication apparatus by the first communication module, when the number of the information items exceeds a preset number.

5. An electronic apparatus comprising:
a first communication module configured to communicate with a first communication apparatus by a first communication method;
a first reception module configured to receive first model type information, which identifies the first communication apparatus, from the first communication apparatus;
a determination module configured to determine an application which is executed in association with the first communication apparatus;
a first transmission module configured to transmit a use history registration message including the first model type information received by the first reception module, second model type information which identifies the electronic apparatus, and information indicative of the application which is determined by the determination module, to a server which is connected via a network;
a second communication module configured to communicate with a second communication apparatus by a second communication method;
a second transmission module configured to transmit a use history search message including third model type information which identifies the second communication apparatus, and the second model type information, to the server in order to request a search for information corresponding to a combination of the third model type information, the second model type information and the information indicative of the application;
a search result reception module configured to receive from the server a search result related to the use history search message; and
an output module configured to output a message recommending use of the application which is to be executed in communication with the second communication apparatus by the first communication module, on the basis of the search result.

6. The electronic apparatus of claim 5, wherein the search result includes a number of information items relating to each of said applications, which corresponds to the combination of the third model type information, the second model type information and the information indicative of the application, which are included in the use history search message, and
the output module is configured to output, on the basis of an order of the number of information items of each of the applications.
